(19) United States
(12) Patent Application Publication
(10) Pub. No.: US 2008/0036626 A1
(43) Pub. Date: Feb. 14, 2008

(54) Navigation apparatus and method for a vehicle on which traffic lane guide image is displayed

(75) Inventor: Hee Seok Kim, Ichon-si (KR)

Correspondence Address: STAAS & HALSEY LLP, SUITE 700, 1201 NEW YORK AVENUE, N.W., WASHINGTON, DC, 20005, US

(73) Assignee: HYUNDAI AUTONET CO., LTD., Ichon-si (KR)

(21) Appl. No.: 11/705,526

(22) Filed: Feb. 13, 2007

(30) Foreign Application Priority Data
Mar. 14, 2006 (KR) 10-2006-0023336

(51) Int. Cl. G08G 1/123

(52) U.S. Cl. 340/995.14; 701/211

(57) ABSTRACT

The present invention relates to a navigation apparatus and method for a vehicle on which a traffic lane guide image is displayed so that an optimal traffic lane can be selected based on road information of a next section when a vehicle is driven. According to an aspect of the present invention, the shortest route between a current location of a vehicle and a desired destination is determined. When the vehicle turns left or right at the intersection, etc., an optimal traffic lane can be decided in advance. Accordingly, there is an advantage in that when a driver drives a vehicle, driving convenience can be improved.

### CROSS-REFERENCE TO RELATED APPLICATION

This application claims the benefit of Korean Application No. 10-2006-0023336, filed Mar. 14, 2006, in the Korean Intellectual Property Office, the disclosure of which is incorporated herein by reference.

### BACKGROUND OF THE INVENTION

1. Field of the Invention

The present invention relates generally to a navigation apparatus for a vehicle, and more particularly to a navigation apparatus for a vehicle on which a traffic lane guide image is displayed so that an optimal traffic lane can be selected based on road information of a next section when a vehicle is driven.

2. Description of the Related Art

Today, a variety of mobile bodies such as shipping, aircraft and vehicles are mounted with a GPS (Global Positioning system) to confirm a current location and a moving speed and/or deciding a moving route.

The GPS, so-called a navigation apparatus receives an electric wave indicating latitude, longitude, altitude, etc. from a plurality of artificial satellites belonging to a global positioning system, calculates a current location of a moving body and displays scaled map information including a current location on the screen for a user.

That is, a common navigation device calculates a current location of a moving body by employing information received from the GPS and displays a calculated current location on the map displayed on the screen.

Furthermore, the navigation apparatus displays thereon various pieces of information, such as a traveling route, the degree of congestion of a road, etc.

However, the common navigation apparatus does not have information capable of selecting a traffic lane. Accordingly, a problem arises because a beginner driver, etc. does not select a proper traffic lane depending on a change in road situations.

### SUMMARY OF THE INVENTION

Additional aspects and/or advantages of the invention will be set forth in part in the description which follows and, in part, will be apparent from the description, or may be learned by practice of the invention.

Accordingly, the present invention has been made in view of the above problems occurring in the prior art, and it is an aspect of the present invention to provide a navigation apparatus for a vehicle on which a traffic lane guide image is displayed so that an optimal traffic lane can be selected based on road information of a next section when a vehicle is driven.

According to an aspect of the present invention, there is provided a navigation apparatus for a vehicle on which a traffic lane guide image is displayed, including a GPS information receiver 10 to receive an electric wave, and a current location of a vehicle and road information (for example, a straight-ahead road, right- and right-turn roads and road intersections) from a plurality of artificial satellites belonging to a GPS through an antenna 100; a current location calculation unit 20 to receive the current location from the GPS information receiver 10, calculating traveling information such as a current location and ongoing direction of the vehicle, and transferring traveling information of the vehicle, which has been finally calculated, to a system control unit 30; the system control unit 30 to receive information from the current location calculation unit 20 and controlling various components that are electrically connected to each other; a map information storage unit 40 serving to interface a driver and the navigation apparatus, to store therein map information and additional data and transferring data to the system control unit 30; a manipulation unit 50 including a keypad having a plurality of keys, to allow a driver to set a desired command; a map matching module unit 60 to match data of the GPS and shape information of an electronic map and to determine a road on which the vehicle is currently driven; a route guide module unit 70 to acquire traffic lane information about the road on which the vehicle is currently driven based on information received from the map matching module unit 60; a traffic lane guide module unit 80 to guide a traffic lane as an arrow (for example, information such as the number of arrows to be overlapped with each other, a location of a center of the arrow, and to which direction the arrow is oriented is reflected on the name of an image, and the usage as only the name of an image file) based on information received from the route guide module unit 70, wherein various kinds of arrows for traffic lane indication images are stored in the traffic lane guide module unit 80; and a display unit 90 to display various pieces of information under the control of the system control unit 30, wherein the display unit 90 displays the information such as the number of arrows to be overlapped with each other, a location of a center of the arrow, and to which direction the arrow is oriented is reflected on the name of an image, and the usage as only the name of an image file, when a traffic lane image is displayed.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram showing the construction of a navigation apparatus for a vehicle on which a traffic lane guide image is displayed according to an embodiment of the present invention; and

FIGS. 2A and 2B are views illustrating traffic lane guide images represented by a traffic lane guide module unit shown in FIG. 1.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

A navigation apparatus for a vehicle on which a traffic lane guide image is displayed according to an aspect of the present invention will now be described in detail in connection with a specific embodiment with reference to the accompanying drawings.

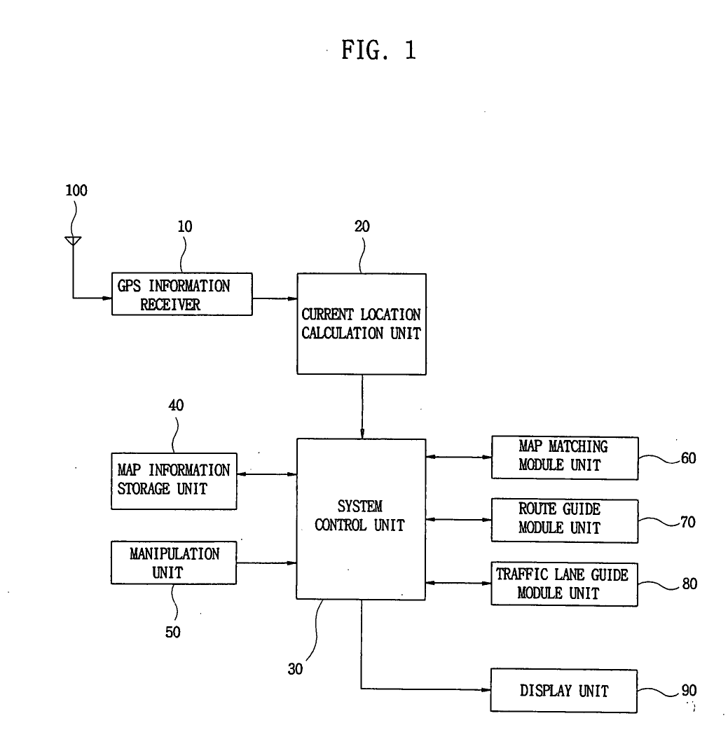

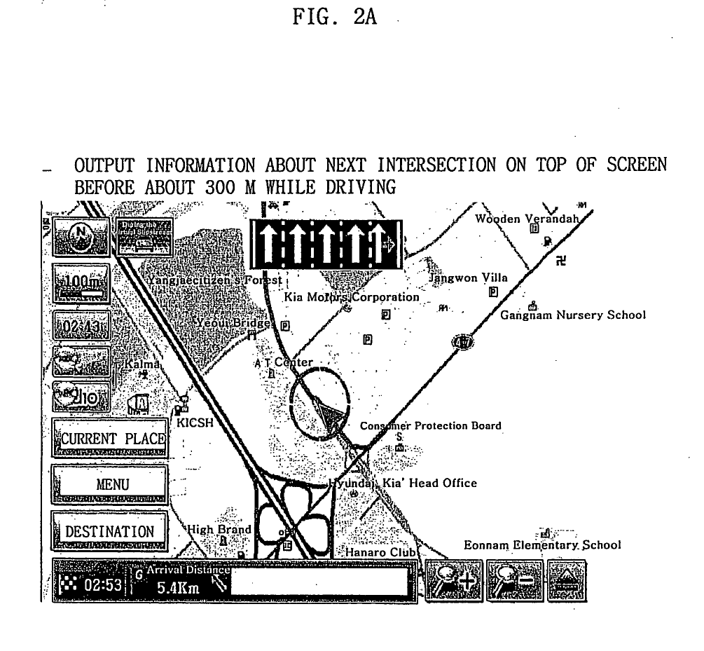

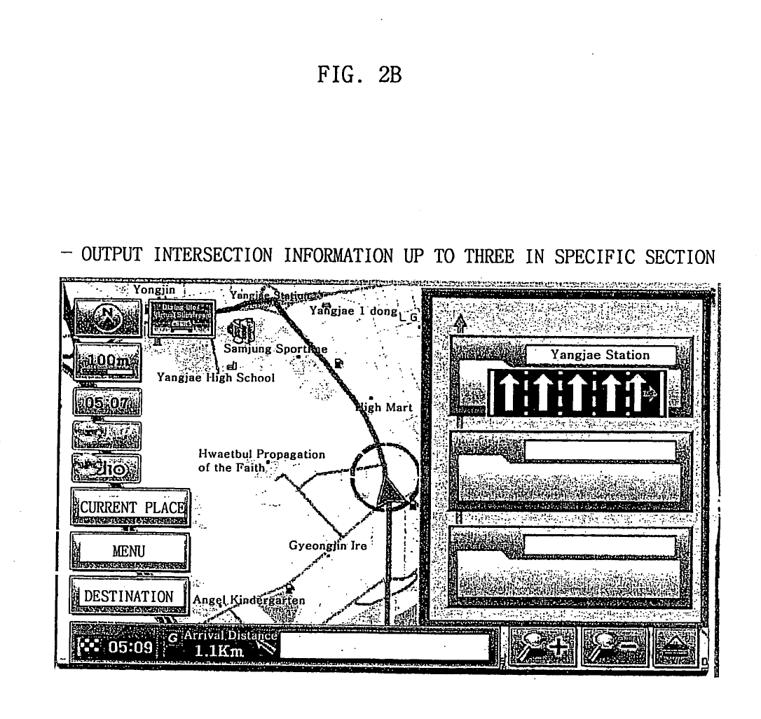

FIG. 1 is a block diagram showing the construction of a navigation apparatus for a vehicle on which a traffic lane guide image is displayed according to an embodiment of the present invention.

Referring to FIG. 1, the navigation apparatus according to an embodiment of the present invention includes a GPS information receiver 10, a current location calculation unit 20, a system control unit 30, a map information storage unit 40, a manipulation unit 50, a map matching module unit 60, a route guide module unit 70, a traffic lane guide module unit 80 and a display unit 90.

The GPS information receiver 10 receives an electric wave from a plurality of artificial satellites belonging to the GPS through an antenna 100. The current location calculation unit 20 calculates traveling information, such as a current location and ongoing direction of a vehicle based on information received from the GPS information receiver 10.

The system control unit 30 controls various components that are electrically connected to each other based on information received from the current location calculation unit 20. The map information storage unit 40 serves to interface a driver and the navigation apparatus, and it stores therein map information and additional data and transfers stored information to the system control unit 30.

The manipulation unit 50 includes a keypad having a plurality of keys, etc. and allows a driver to transfer a desired command to the system control unit 30. The map matching module unit 60 serves to match data of the GPS and shape information of an electronic map, determine a road on which a vehicle is currently driven and transfers the results to the system control unit 30.

The route guide module unit 70 acquires traffic lane information about the road on which the vehicle is currently driven based on information received from the map matching module unit 60, and transfers acquired information to the system control unit 30.

The traffic lane guide module unit 80 guides the traffic lane as an arrow (for example, information such as the number of arrows to be overlapped with each other, the location of the center of the arrow, and to which direction the arrow is oriented is reflected on the name of an image, and the usage as only the name of an image file) based on information received from the route guide module unit 70. The display unit 90 displays thereon various pieces of information under the control of the system control unit 30.

The operation of the navigation apparatus constructed above will be described below.

The GPS information receiver 10 receives an electric wave, and a current location of a vehicle, road information (for example, a straight-ahead road, left- and right-turn roads, a road intersecting point, etc.) and traveling information from a plurality of artificial satellites belonging to the GPS through the antenna 100.

The current location calculation unit 20 receives the current location from the GPS information receiver 10. The current location calculation unit 20 also calculates traveling information, such as the current location and ongoing direction of the vehicle, and transfers traveling information of the vehicle, which has been finally calculated, to the system control unit 30.

The system control unit 30 receives information from the current location calculation unit 20 and controls various components that are electrically connected to each other.

The map information storage unit 40 serves to interface a driver and the navigation apparatus. The map information storage unit 40 stores therein map information and additional data and transfers data to the system control unit 30.

The manipulation unit 50 includes a keypad having a plurality of keys, and allows a driver to set a desired command.

The map matching module unit 60 matches data of the GPS and shape information of an electronic map and determines a road on which the vehicle is currently driven.

The route guide module unit 70 acquires traffic lane information about a road on which the vehicle is currently driven based on information received from the map matching module unit 60.

The traffic lane guide module unit 80 guides a traffic lane as an arrow (for example, information such as the number of arrows to be overlapped with each other, a location of a center of the arrow, and to which direction the arrow is oriented is reflected on the name of an image, and the usage as only the name of an image file) based on information received from the route guide module unit 70. In this case, various kinds of arrows for traffic lane indication images are stored in the traffic lane guide module unit 80.

The display unit 90 displays thereon various pieces of information under the control of the system control unit 30. The display unit 90 displays information, such as the number of arrows to be overlapped with each other, a location of a center of the arrow, and to which direction the arrow is oriented is reflected on the name of an image, and the usage as only the name of an image file, when a traffic lane image is displayed.

It is preferred that an arrow image represented on a traffic lane be displayed as various colors.

For example, a gray arrow may indicate a direction on which a vehicle can drive on a current traffic lane, a white arrow indicate a direction on which the vehicle must drive according to route search, and a blue arrow indicate a recommended traffic lane considering a next intersection.

Furthermore, five arrow images including three gray images, one white image and one blue image at the maximum for one traffic lane may be overlapped with each other and represented. The size of an image to be used in a common traffic lane may be relatively large, and the size of an image of an increment traffic lane that is increased immediately before the intersection may be relatively small.

An embodiment of the present invention, the arrow is as follows.

The arrow includes an arrow for a common traffic lane, an arrow for an increment and decrement traffic lane, and so on.

The arrow includes an arrow for a common traffic lane includes an arrow for sole expression, an arrow for two-combination expression, and an arrow for three-combination expression.

The arrow for sole expression includes straight-ahead, upper right, right turn, lower right, U-turn, lower left, left turn and upper left.

The arrow for two-combination expression includes upper right, right turn, lower right, lower left, left turn and upper left when the arrow body is located at the center, straight-ahead, upper right (long and short), right turn (long and short) and lower right when the arrow body is located on the left side, and straight-ahead, U-turn, lower left (short), lower left (long), left turn (short), left turn (long), upper left (short) and upper left (long) when the arrow body is located on the right side.

The arrow for three-combination expression includes straight-ahead, upper right (long upper part and short lower part 20 degrees, 45 degrees, and short lower part 70 degrees), 90 degrees, lower right (110 degrees, 135 degrees and 160 degrees), right turn, and lower left (200 degrees, 225 degrees and 250 degrees) when the arrow body is located at the center; straight-ahead, upper right (20 degrees, 45 degrees and short upper part 70 degrees), right turn (long lower part, middle lower part and short lower part), and lower right (110 degrees, 135 degrees and 160 degrees) when the arrow body is located on the left side; and straight-ahead, U-turn, lower left (200 degrees, 225 degrees and 250 degrees), left turn (long lower part, middle lower part and short lower part), and upper left (short upper part 290 degrees, 315 degrees, and short upper part 340 degrees) when the arrow body is located on the right side.

Furthermore, the arrow for increment and decrement traffic lanes includes an arrow for a common traffic lane, which is asymmetrically reduced, and an arrow lower part that is cut.

The display unit 90 displays various pieces of information under the control of the system control unit 30. The display unit 90 displays the information such as the number of arrows to be overlapped with each other, a location of a center of the arrow, and to which direction the arrow is oriented is reflected on the name of an image, and the usage as only the name of an image file, when a traffic lane image is displayed.

In this case, the number of arrows to be overlapped with each other, for example, several gray arrows are combined to represent information of one traffic lane. The location of the center of the arrow, for example, when the arrow body is located on the left side, it is represented as “L”, when the arrow body is located at the center “C”, and when the arrow body is located on the right side “R”. A direction code indicating to which direction the arrow is oriented, for example, straight-ahead, 45 degrees, right turn, 135 degrees, U-turn, 225 degrees, left turn 315 degrees are represented.

As described above, according to the present invention, the shortest route between a current location of a vehicle and a desired destination is determined. When the vehicle turns left or right at the intersection, etc., an optimal traffic lane can be decided in advance. Accordingly, there is an advantage in that when a driver drives a vehicle, driving convenience can be improved.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A navigation apparatus for a vehicle on which a traffic lane guide image is displayed, the apparatus comprising:
a GPS (Global Positioning System) information receiver to receive an electric wave, and a current location of a vehicle and road information including a straight-ahead road, right- and right-turn roads and road intersecting point from a plurality of artificial satellites belonging to a GPS through an antenna;
a current location calculation unit to receive the current location from the GPS information receiver, calculating traveling information such as a current location and ongoing direction of the vehicle, and transferring traveling information of the vehicle, which has been finally calculated, to a system control unit;
the system control unit to receive information from the current location calculation unit and controlling various components that are electrically connected to each other;
a map information storage unit serving to interface a driver and the navigation apparatus, to store therein map information and additional data and transferring data to the system control unit;
a manipulation unit including a keypad having a plurality of keys, to allow a driver to set a desired command;
a map matching module unit to match data of the GPS and shape information of an electronic map and determining a road on which the vehicle is currently driven;
a route guide module unit to acquire traffic lane information about the road on which the vehicle is currently driven based on information received from the map matching module unit;
a traffic lane guide module unit to guide a traffic lane as an arrow (for example, information such as the number of arrows to be overlapped with each other, a location of a center of the arrow, and to which direction the arrow is oriented is reflected on the name of an image, and the usage as only the name of an image file) based on information received from the route guide module unit, wherein various kinds of arrows for traffic lane indication images are stored in the traffic lane guide module unit; and
a display unit to display various pieces of information under the control of the system control unit, wherein the display unit displays the information such as the number of arrows to be overlapped with each other, a location of a center of the arrow, and to which direction the arrow is oriented is reflected on the name of an image, and the usage as only the name of an image file, when a traffic lane image is displayed.

2. The navigation apparatus of claim 1, wherein the arrow includes a gray arrow indicating a direction on which the vehicle can be driven on a current traffic lane, a white arrow indicating a direction on which the vehicle must be driven according to route search, and a blue arrow indicating a recommended traffic lane considering a next intersection.

3. The navigation apparatus of claim 1, wherein the arrow can represent five arrow images including three gray images, one white image and one blue image at the maximum for one traffic lane, which are overlapped with each other.

4. A method of displaying for a vehicle on which a traffic lane guide image is displayed, the method comprising:
calculating traveling information of the vehicle based on a current location and ongoing direction of the vehicle;
determining a road on which the vehicle is currently driven; and
displaying a traffic lane of the road on which the vehicle is currently driven.

5. A display, comprising:
a road graphic;
a vehicle graphic positioned on the road graphic; and
arrow graphics positioned in association with the road graphic and indicating a direction in which the vehicle can be driven in a current traffic lane, indicating a direction in which the vehicle must be driven according to a calculated route, and indicating a recommended traffic lane considering a next intersection.
